(19) United States
(12) Patent Application Publication
(10) Pub. No.: US 2017/0220324 A1
(43) Pub. Date: Aug. 3, 2017

(54) DATA COMMUNICATION ACCELERATOR SYSTEM

(71) Applicant: Syntel, Inc., Troy, MI (US)

(72) Inventors: Ashok Balasubramanian, Chennai Tamilnadu (IN); Maneesh Misra, Mumbai (IN); Karthikeyan Krishnaswamy Raja, Chennai Tamilnadu (IN)

(21) Appl. No.: 15/420,665

(22) Filed: Jan. 31, 2017

Related U.S. Application Data
(60) Provisional application No. 62/289,648, filed on Feb. 1, 2016.

(51) Int. Cl. G06F 9/44; H04L 29/08; G06F 11/36

(52) U.S. Cl. CPC G06F 8/20; G06F 11/368; G06F 11/3676; H04L 67/10

(57) ABSTRACT

A data communication system may include a computer server that may include a processor, a memory; and a computer program encoded on said memory. The computer program may be configured to implement system logic when executed by said processor. The system logic may include a process manager, a user interface, a communication bus, and a database. The process manager may be configured to automatically execute a plurality of custom processes. The process manager may be configured for receiving a request for the code development project. The process manager may be configured for receiving, via the user interface, a request for an electronic environment, and the electronic environment may be configured for modifying the code development project. The process manager may be configured for provisioning the electronic environment according to the request and providing the environment via a virtual machine.

### CROSS-REFERENCE TO RELATED APPLICATIONS

This application claims the benefit of U.S. provisional application No. 62/289,648, filed Feb. 1, 2016 (the '648 application). The '648 application is hereby incorporated by reference as though fully set forth herein.

### BACKGROUND

a. Technical Field

The present disclosure relates to a system, method, and article of manufacture configured to provide accelerated data communications and to integrate different applications that may be used in a larger project.

b. Background Art

This background description is set forth below for the purpose of providing context only. Therefore, any aspects of this background description, to the extent that it does not otherwise qualify as prior art, is neither expressly nor impliedly admitted as prior art against the instant disclosure.

As organizations continue to take advantage of newer technologies, being able to efficiently adapt to and integrate such new technologies may be desirable. Conventional systems often only address one aspect of a project and do not adequately/efficiently communicate with other systems/components. In some conventional systems, significant manual intervention is required, which may increase cycle time, increase downtime, limit productivity, and/or otherwise limit the efficiency of various systems. There is, therefore, a need for solutions that allow for more efficient communications and/or improve the efficiency of various systems.

The foregoing discussion is intended only to illustrate the present field and should not be taken as a disavowal of claim scope.

### SUMMARY

In embodiments, a data communication system may include a computer server that may include a processor, a memory, and a computer program encoded on said memory. The computer program may be configured to implement system logic when executed by said processor. The system logic may include a process manager, a user interface, a communication bus, and a database. The process manager may be configured to automatically execute a plurality of custom processes. The process manager may be configured for receiving a request for the code development project. The process manager may be configured for receiving, via the user interface, a request for an electronic environment, and the electronic environment may be configured for modifying the code development project. The process manager may be configured for provisioning the electronic environment according to the request and providing the environment via a virtual machine.

In embodiments, provisioning may include determining an environment type from the request, determining an environment blueprint of the requested electronic environment, and invoking a target communication interface, according to the determined environment type and determined environment blueprint, to create the virtual machine.

In embodiments, process manager may be configured to receive a project completion message upon complete of the project, analyze the project according to a plurality of project review rules, and/or generate a report according to the review of the completed project.

In embodiments, at least one custom process may correspond to an information technology (IT) incident and the processor may be configured to automatically remediate the IT incident. In embodiments, automatically remediating the IT incident may include one or more of (i) receiving an incident message including information corresponding to the IT incident; (ii) creating an incident ticket according to the incident message; (iii) determining, according to the incident ticket, if one or more existing processes are configured for remediating the IT incident; (iv) executing one or more existing processes if the one or more existing processes are configured for remediating the IT incident; and/or (v) escalating the incident ticket if the one or more existing processes are not configured for remediating the IT incident.

In embodiments, a method for high efficiency data communications via a computer network may include providing a computer server that may include a processor and a memory coupled to the processor. The method may include providing a system logic disposed in said memory and said system logic may comprise at least one of instructions and code. The method may include receiving a process execution request and automatically executing, via a process manager of said system logic, a custom process according to the process execution request. The method may include exporting the project request to a process tracking tool. In embodiments, the custom process may correspond to a code development project. In embodiments, automatically executing the custom process may include (i) receiving an request for an electronic environment, the electronic environment configured for modifying the code development project; (ii) provisioning the electronic environment according to the request; and/or (iii) providing the environment via a virtual machine. In embodiments, the provisioning may include (i) determining an environment type according to the request; (ii) determining an environment blueprint according to the request; and/or (iii) invoking a target communication interface according to the determined environment type and determined environment blueprint, to create the virtual machine.

In embodiments, the method may include (i) receiving a project completion message upon completion of the project; (ii) analyzing the completed project according to a plurality of project review rules; and/or (iii) generating a report according to the review of the completed project. In embodiments, analyzing the complete project may include automatically applying a plurality test cases to the project and/or determining a project coverage value. In embodiments, the code coverage value may correspond to an amount of the completed project that has been tested via the plurality of test cases.

The foregoing and other aspects, features, details, utilities, and advantages of the present disclosure will be apparent from reading the following description and claims, and from reviewing the accompanying drawings.

### BRIEF DESCRIPTION OF THE DRAWINGS

FIG. 1 is a block diagram generally illustrating an embodiment of a data communication accelerator system according to the present disclosure.

FIG. 2 is a block diagram generally illustrating an embodiment of a data communication accelerator system according to the present disclosure.

FIG. 3 is a flow diagram generally illustrating an embodiment of a data communication accelerator system according to the present disclosure.

FIG. 4 is a flow diagram generally illustrating an embodiment of a data communication accelerator system according to the present disclosure.

FIG. 5 is a flow diagram generally illustrating an embodiment of a data communication accelerator system according to the present disclosure.

### DETAILED DESCRIPTION

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

Before proceeding to a detailed description of embodiments of the instant disclosure, a general overview of its operation will first be set forth. As described in the Background, data communication, such as via the Internet, is often inefficient.

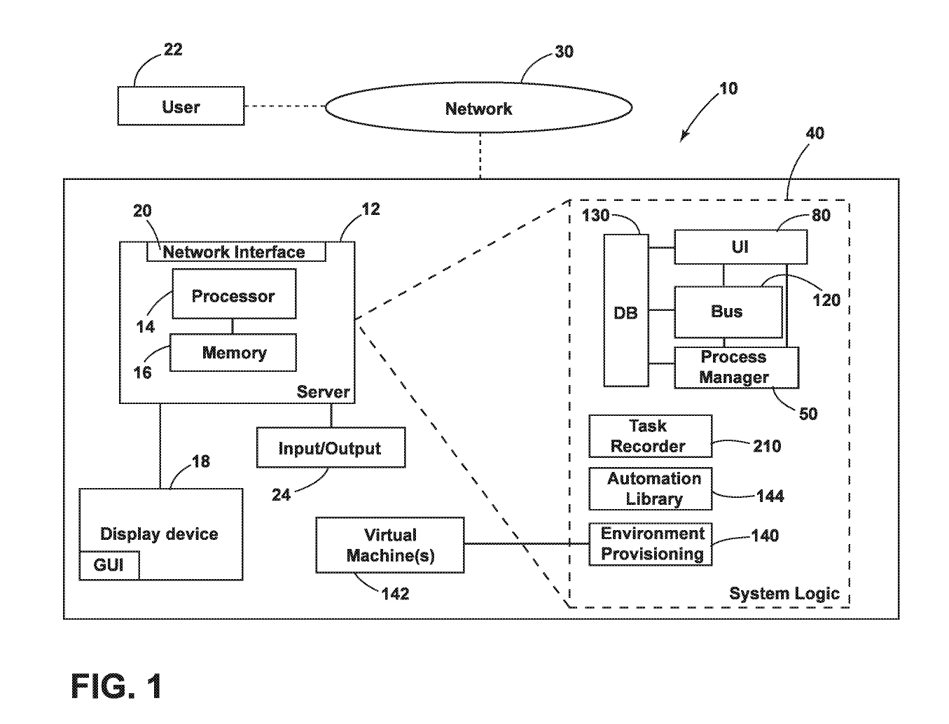

Referring now to the drawings, wherein like reference numerals are used to identify identical or similar components in the various views, FIG. 1 is a diagrammatic and block diagram view of an embodiment of a high efficiency data communication system 10. In embodiments, system 10 may include a server 12 (e.g., a computer server), and/or may include a processor 14 (e.g., an electronic processor), and an memory 16 (e.g., an electronic memory). A system logic 40 may be stored in memory 16 and may include a process manager 50, a user interface (UI) 80, a communication bus 120, a database (DB) 130, and/or an environment provisioning module 140. System logic 40 may include code and/or instructions that, when carried out by a processor (e.g., processor 14), may be configured to implement one or more of the features and/or functions described herein of system 10, such as, for example, process manager 50, user interface 80, communication bus 120, database 130, and/or environment provisioning module 140.

In embodiments, server 12 may be configured (e.g., specifically), to control the overall operation of system 10, which may include controlling memory 16, a display device 18 (e.g., an electronic display device), that may be connected to server 12, and/or execution of system logic 40. For instance, overall control may be achieved through execution by one or more processors 14 (only one shown) of server 12. In embodiments, processor 14 may include one or more programmable processors, microprocessors, and/or microcontrollers. In addition, processor 14 may include a central processing unit (CPU), memory (in addition to or such as the illustrated memory 16) and an input/output (I/O) interface 24 through which processor 14 may receive a plurality of input electrical signals including signals, such as generated via user interface 80 and/or other input/output devices, which may be included in I/O interface 24. Such an I/O interface may also be configured to generate a plurality of output signals including those used to control and/or provide data to display device 18.

Memory 16 is provided for storage of data, instructions, and/or code (e.g., system logic 40), and is coupled to at least processor 14. Memory 16 may include various forms of non-volatile (e.g., non-transitory), memory including flash memory, read only memory (ROM) including various forms of programmable read only memory, (e.g., PROM, EPROM, EEPROM), and/or volatile memory such as random access memory (RAM) including static random access memory (SRAM), dynamic random access memory (DRAM), and/or synchronous dynamic random access memory (SDRAM). Although illustrated as a separate component in the illustrated embodiment, it should be understood that memory 16 may be internal to processor 14.

Display device 18 may be configured to display aspects of a graphical user interface (GUI), which may be generated by the operation of system logic 40 (e.g., via user interface 80). Display device 18 may function as an input/output device, as noted above, for the user 22 of system 10 and may include components known in the art. Display device 18 may include, for example only, a liquid crystal display or light emitting diode display or other technologies known in the art. Display device 18 may function as an output device with input received through other I/O devices (e.g., I/O devices 24), such as a keyboard or mouse (not shown). Additionally or alternatively, display device 18 may also function as an input device, such as a touch screen display that may include, for example, capacitive and/or resistive touch screen displays, and/or other technologies.

In embodiments, system 10 may be connected to a network 30 (e.g., a computer network), by way of a network interface 20. Network 30 may include, for example, an intranet (e.g., a local area network or “LAN”), the Internet, a cellular network, and/or other networks.

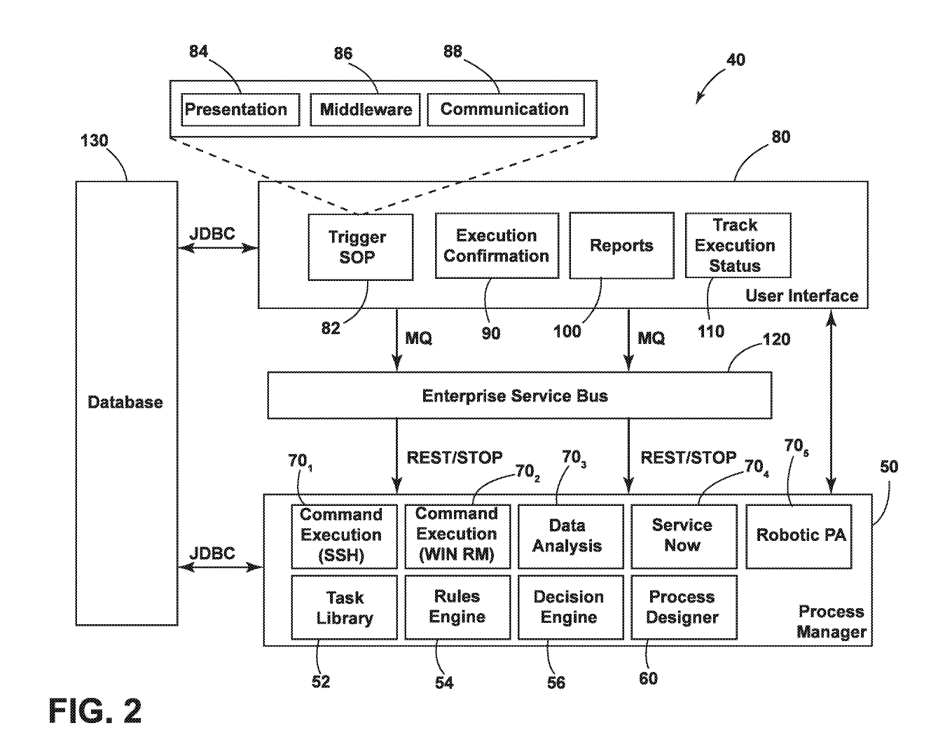

In embodiments, such as generally illustrated in FIGS. 1-2, system 10 and/or system logic 40 may include a process manager 50. Process manager 50 may be configured to control the operation of one or more processes. In embodiments, process manager 50 may be configured to be compliant with one or more industry standards, such as Business Process Model and Notation (BPMN) 2.0. For example, and without limitation, some or all components of process manager 50 may be designed and/or modeled using open source technologies. In embodiments, process manager 50 may include and/or may be built, at least in part, on a workflow engine, which may include open-source components. In embodiments, process manager 50 may include a task library 52 that may provide atomic tasks for completion across infrastructure components, such as databases, middleware servers, and/or others.

In embodiments, system 10 and/or system logic 40 may include a rules engine. In embodiments, rules engine 54 may include and/or be connected to a decision engine 56 that may be configured to receive a set of data from a process and apply a set of conditions to dictate a particular action in process execution. The conditions may be configurable by a user and may be versioned and/or deployed at runtime. The rules may be written in one or more languages, such as, for example, Java® and/or an expression language. In embodiments, rules engine 54 may execute separately from process manager 50, may be disposed on the same server as process manager 50 (e.g., on server 12), and/or may be integrated with process manager 50.

In embodiments, process manager 50 may include task library 52, which may include prefabricated tasks that may be configured to be assembled with other tasks to generate a workflow. Prefabricated tasks may be used, reused, and/or modified for one or more of a variety of tasks. In embodiments, a process designer 60 may be configured for generating the prefabricated tasks. Process designer 60 may permit a user 22, such as via user interface 80, to generate prefabricated tasks, which may include service details, input and output mapping, and/or other logic rules as desired. In embodiments, task library 52 may include prefabricated tasks that may be used, for example, in connection with automated code review, automated code release, and/or other processes. In embodiments, process manager 50 may permit a user 22 to generate a workflow via dragging and dropping prefabricated tasks onto/into a design canvas. In embodiments, prefabricated tasks may include, for example, creating a new user in an active directory, providing schema access to a database user (e.g., an Oracle database user), restarting an operating system service (e.g., a Windows® and/or Unix® service), triggering a job in an automation tool/server (e.g., Jenkins®), transferring a file via the file transfer protocol (FTP), parsing an extensible markup language (XML) file, and/or others.

In embodiments, such as generally illustrated in FIG. 2, process manager 50 may include one or more service adapters 70_{N} that may be configured to allow process manager 50 to communicate with other (e.g., third party), applications and/or device. For example, and without limitation, process manager may include a first command execution adapter 70₁, a second command execution adapter 70₂, a data analysis adapter 70₃, a service now adapter 70₄, and/or a robotic process automation (PA) adapter 70₅. Service adapters 70_{N} may be configured to use application programming interfaces (APIs) of other applications or devices. One or more of service adapters 70_{N} may, for example, be implemented as plain old Java® object (POJO) services, which may be exposed as standard web services, such as based on REST (representational state transfer) and/or SOAP (simple object access protocol) protocols. In embodiments, one or more service adapters may be implemented via a custom framework, such as a custom Java® framework. In embodiments, a custom framework may be configured to ensure work item classes are generalized to receive configuration parameters to execute an end activity. Such a framework may reduce the amount of code deployment to process manager and may provide greater control over the security of task execution. In embodiments, one or more of service adapters 70_{N} may include one or more authentication mechanisms, such as, for example, form-based authentication, active directory (AD) authentication, lightweight directory access protocol authentication, certificate-based authentication, and/or other desired authentication mechanisms.

In embodiments, first command execution adapter 70₁ and/or second command execution adapter 70₂ may be configured to communicate with certain other applications and/or devices, such as third party applications. For example, and without limitation first command execution adapter 70₁ may be configured to communicate with Linux® applications and/or devices and may be configured to communicate via the Secure Shell network protocol (SSH). In embodiments, first command execution adapter 70₁ may be configured to use a Java® API to connect to a Linux®/Unix® server through a socket and may send instructions and/or commands to be execution the server. A response of the execution of the command may be returned to first command execution adapter 70₁.

In embodiments, second command execution adapter 70₂ may, for example, be configured for communication with Windows® applications and/or devices, and may be configured to communicate via Windows Remote Management (WinRM). In embodiments, second command execution adapter 70₂ may include components (e.g., Java® components), that may be used to call WinRM SOAP-based web services. Second command execution adapter 70₂ may be configured to receive input commands and/or data, and may create requested data in a format required by WinRM to execute the command on a Windows® server. The overall structure of second command execution adapter 70₂ may be similar to other adapters (e.g., first command execution adapter), which may permit/allow for reuse and/or may permit better maintainability.

In embodiments, data analysis adapter 70₃ may be configured to analyze text, such as via parsing text and/or files. For example, and without limitation, data analysis adapter 70₃ may be configured to compare rows and/or columns of tables (e.g., Excel files, comma separated values files, etc.), and/or to extract data based on conditions that may be set forth in the task definition. In embodiments, data analysis adapter 70₃ may be configured to support extracting node values from certain files, such as, for example, XML and/or Java® script object notation (JSON) format files. The source of data that may be analyzed via data analysis adapter 70₃ may include, for example, files, databases, email, messages, and/or others.

In embodiments, service now adapter 70₄ may be configured to integrate system 10 and/or system logic 40 with an information technology service management (ITSM) tool, which may permit one or more of a variety functions. For example, and without limitation, such functions may include querying a technical support ticket, updating a ticket, and/or creating a ticket. In embodiments, service now adapter 70₄ may be configured to communicate with and/or use web services provided by the ITSM tool.

In embodiments, robotic PA adapter 70₅ may be configured to mimic and/or replace a user's actions/interaction with one or more applications, such as, for example, web-based applications, Windows® applications, and/or mainframe applications. In embodiments, robotic PA adapter 70₅ may be configured to perform screen-level action as if a user was actually performing such actions. Robotic PA adapter 70₅ may be configured to be non-intrusive such that it does not modify any components of the applications. In embodiments, robotic PA adapter 70₅ may be built on a Java® platform and may use one or more APIs exposed by Windows® and/or mainframe emulators to enter data, select form elements, copy data from the screen, and/or other action. In embodiments, robotic PA adapter 70_{N} may be configured to assist in executing a process transaction on the application in an automated and/or automatic fashion (e.g., without user intervention).

In embodiments, process manager 50 may include one or more other service adapters 70_{N} that may each be configured to communicate with a particular program (e.g., via the program's API). In embodiments, additional service adapters may be added if it is desired to provide system 10 with additional programs/functionality. For example, and without limitation, process manager 50 may include one or more separate adapters 70_{N} for Maven® and/or Jenkins®.

In embodiments, system logic 40 may be configured to provide/generate user interface 80, which may be configured to allow a user 22 to interact with system 10. For example, and without limitation, user interface 80 may include and/or may be configured to generate a GUI, via which a user 22 may perform administrative activities, perform configuration-type activities, monitor system executions, start workflows, view reports, and/or other actions. In embodiments, user interface 80 may include a user interface module. In embodiments, user interface 80 may include a trigger standard operating procedure (SOP) component/module 82. In embodiments, trigger SOP module 82 may be configured to register a workflow in system 10, which may permit the workflow to be used. In embodiments, trigger SOP module 82 may include default parameters and/or may determine one or more parameters that are to be received from a user 22. Trigger SOP module 82 may be configured to control which execution parameters are shown to a user 22 and/or may control encryption/security requirements. In embodiments, trigger SOP module 82 may include a multi-tier web application configuration, which may include a presentation tier 84, a middleware tier 86, and/or a communication tier 88. In embodiments, presentation tier 84 may be configured to communicate with a display device (e.g., display 18). In embodiments, middleware tier 86 may include server side components that may control the logic that may be used for executing a requested service, as such executing a particular service may include a plurality of steps. In embodiments, communication tier 88 may be configured to communicate with a repository, such as, for example, a database (e.g., database 130).

In embodiments, user interface 80 may include an execution confirmation module 90. Execution confirmation module 90 may be configured for determining and/or storing the results of the execution of a workflow. In embodiments, execution confirmation module 90 may obtain details of the individual actions of a particular workflow, which may include a date/time and log of the execution. In embodiments, execution confirmation module 90 may be implemented in a similar manner to one or more other modules (e.g., trigger SOP module 82).

In embodiments, user interface 80 may include a reports module 100 that may be configured to provide reports that may be customized by a user 22. In embodiments, a report may include a view of system executions with respect to parameters such as date/time, SOP category, system health, and/or others. Data used in such reports may obtained via other components of system (e.g., via process manager 50), and/or may be obtained from other systems (e.g., external and/or integrated systems). In embodiments, reports module 100 may be implemented via one or more open source reporting platforms that may be configured to define one or more report templates. Report templates may include, for example, information regarding a query that may be executed for displaying data for each report type. In embodiments, reports may include grids, tables, charts (e.g., bar, pie, line, etc.), and/or others.

In embodiments, user interface 80 may include an execution status tracker 110. In embodiments, execution status tracker 110 may be configured to view the runtime state of one or more workflow processes that may be running on system 10. Execution/runtime statuses may include, for example, and without limitation, invoked, executing, complete, failed, and/or others. In embodiments, execution status tracker 110 may be configured to fetch execution statuses, such as may be logged by execution confirmation module 90.

In embodiments, communication bus 120 may be configured to allow/facilitate process manager 50 and user interface 80 to communicate with each other. In embodiments, communication bus 120 may be configured as a service bus (e.g., an enterprise service bus). In embodiments, communication bus 120 may be configured to receive messages/information from user interface 80 in a first format (e.g., a message queue, such as IBM® MQ), and convert/transform that message/information into a second format (e.g., compatible with REST and/or SOAP). Communication bus may then provide the converted messages/information to process manager. In embodiments, if a request is submitted via user interface 80 using a form, the request may be communicated directly to process manager 50, bypassing communication bus 120 (e.g., communication bus 120 may selectively facilitate communication between process manager 50 and user interface 80). In embodiments, outputs and/or responses from process manager 50 may be communicated directly to user interface 80, bypassing communication bus 120. In embodiments, user interface 80 and/or process manager 50 may be configured to communicate with database 130 (e.g., via Java® Database Connectivity, JDBC®). In embodiments, database 130 may include, for example, configuration data, user access data, process execution data, audit trail data, workflow command parameters, and/or other data. In embodiments, database 130 may include a MySQL® database.

In embodiments, communication bus 120 may be implemented via exposing services as web services that may be accessed according to industry standards. The web service may connect system 10 with external systems and/or allow external systems and/or persons to interface with system 10. In embodiments, data format conversion may be conducted, for example, via Java® APIs.

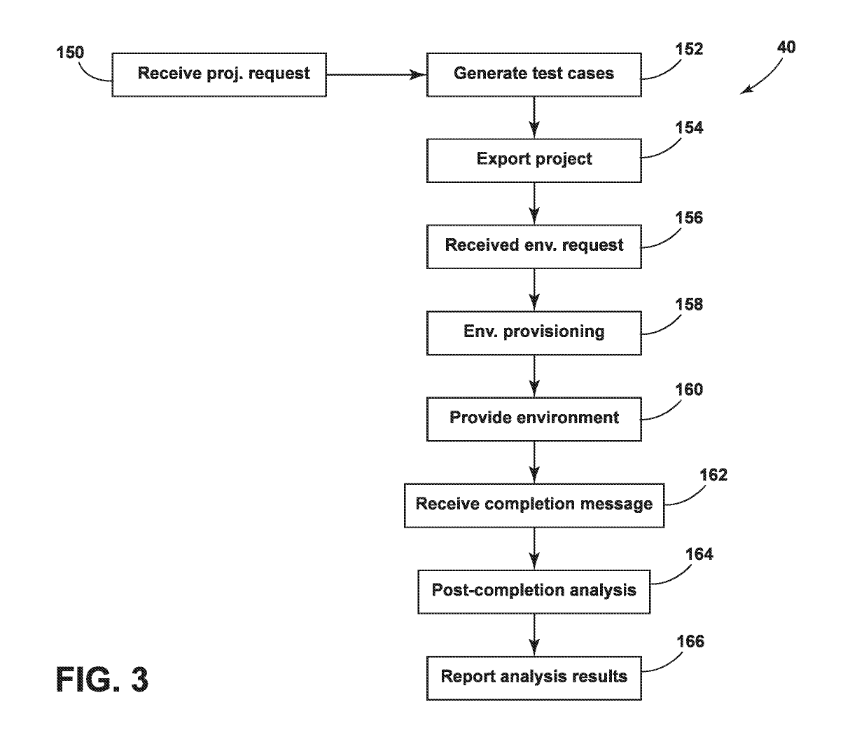

In embodiments, such as generally illustrated in FIGS. 1-3, system 10 (and/or system logic 40) may be configured to provide a single portal through which one or more different electronic environments may be accessed. For example, and without limitation, system 10 may, in step 150, receive a project request (e.g., a custom process request). In embodiments, the project request may be modeled as a BPMN process. In embodiments, the project request may include/correspond to a code development project. In embodiments, system logic 40 may, in step 152, generate test cases according to the project request (e.g., according to the BPMN process). In embodiments, system 10 may, in step 154, export the project request and/or the BPMN process to process manager 50, which may include and/or be connected to an agile management tool (e.g., JIRA®). In embodiments, a user 22 may begin working on the requested project, and/or may, via user interface 80, be permitted to select/request a desired electronic environment type. The electronic environment types may be predefined, such as by an administrator, and may include information on the target environment, such as target environment interface information, server computing power, server memory, server storage, and/or software details. In step 156, system 10 may receive the environment selection/request.

In embodiments, system logic 40 may include an environment provisioning module 140 that may be configured to provision environments (e.g., in step 158), such as according to environment blueprints and/or to the environment type requested by the user. In embodiments, environments may include, for example, software project development environments. In embodiments, system logic 40 may invoke one or more APIs of a target environment to create a virtual machine 142 (e.g., via respective adapters of process manager 50). For example, and without limitation, environments may include those available from OpenStack®, VmWare®, Amazon®, Microsoft (e.g., Azure and/or others. Environment provisioning module 140 may be configured to communicate with process manager 50 for one or more potential aspects of environment provisioning, such as, for example, creating virtual machines (VM) 142, installing software, installing services, and/or others.

In embodiments, system logic 40 may be configured to determine and/or obtain environment blueprints that may include hardware configurations of the servers in the desired environment and/or the software stack that may be required on such servers for creating virtual machines 142. For example, and without limitation, system 10 may be configured to receive (e.g., via user interface 80), environment blueprints and/or data for constructing such blueprints. In embodiments, a plurality of environment types may be available, such as custom template, a stack template, and/or bespoke. In embodiments, each template may include definitions/requirements, such as CPU, RAM, memory, software stack specifications, firewall settings, and/or others. Each template may be configured for creating an instance of an environment in an end user self-service mode. For example, and without limitation, user interface 80 may be configured to receive input from a user 22 to generate environment templates.

In embodiments, system logic 40 may include and/or may communicate with an internal software automation library 144, which may include, for example custom shell scripts, Powershell® scripts, Jython scripts, Puppet® scripts, Chef™ scripts, and/or other software configuration management (SCM) tools, to install the chosen software stack in the chosen environment (e.g., according to determined/obtained blueprints). Once the environment has been provisioned, the environment may, in step 160, be provided to the user 22 (e.g., to work on a project or task).

In embodiments, system 10 (and/or system logic 40) may be configured, in step 162, to receive a message/indication that work in the environment is complete (e.g., a project or task is complete). For example, and without limitation, user interface 80 may permit a software developer to provide an indication that work is complete, and system 10 may be configured to receive that indication. In embodiments, the user 22 may commit the project to a version control tool (e.g., Apache® Subversion®), that may be connected to and/or integrated with system logic 40. In response to a completion indication, system logic 40 may trigger a build, such as a build of the code of the completed project/task. In embodiments, a build may be accomplished, at least in part, via continuous integration and/or via a build automation tool, such as, for example, Jenkins®. In embodiments, continuous integration may include a workflow of different steps that may be used to create a deployment package from the completed code and/or conduct other steps, such as, for example, deploy, test, and/or others. In embodiments, one or more steps of the workflow may call services of system 10 that may be configured to interface with other tools. The other tools may carry out individual steps, such as on different servers. In embodiments, each step in the workflow may include configurations on the actual services being invoked and/or input/output parameter mapping.

In embodiments, once a project/task has been completed and/or system has received a completion indication, system logic 40 may be configured for automatically conducting post-completion tasks (e.g., in step 164). For example, and without limitation, post-completion tasks may include automatically conducting an automated review of the code of the completed project. In embodiments, automated code review may be modeled as a process for management by process manager 50. For example, and without limitation, if a workflow includes an automated code review step, which may include details on the desired code review tool/location, code review may be automatically conducted each time the workflow progresses to the automated code review step.

In embodiments, an automated code review process may include, for example, a test execution task. The test execution task may be dynamically configured with the details on the test suite (e.g., a series of test cases), and a repository location for the completed project code to be reviewed. An automated code review process may include automatically downloading test cases of the test suite (e.g., as generated in step 152), and executing the test cases and/or triggering execution via a test automation platform, such as, for example, Selenium®, QuickTest Professional from HP®, and/or others. In embodiments, automated code review may include analyzing the code for mistake and/or errors (e.g., rule violations), such as via a code analyzer tool (e.g., PMD). In embodiments, automated code review may include unit testing, such as via a unit testing framework (e.g., JUnit). Process manager 50 may be configured to automatically collate/assemble the results of the testing and evaluate such results to determine a next step (e.g., integration, deployment, retesting, additional development, etc.).

In embodiments, automated code review may include determining a code coverage amount, which may include the amount (e.g., a percentage), of the completed project code that has actually been tested via the applied test cases. In embodiments, the next steps (e.g., integration, deployment, etc.), may be determined according to the results of the test cases and/or the code coverage amount. For example, and without limitation, if the code coverage amount is less than a predetermined percentage, the completed project code may not continue with deployment and may instead be returned to the developer for additional work and/or system logic 40 may automatically generate additional test cases to apply to the completed project code. In embodiments, code coverage (e.g., a code/project coverage value), may be determined, at least in part, via a code coverage tool, such as a Java® code coverage tool (e.g., EMMA, JaCoCo, etc.). In embodiments, automated code review may include determining a number of blocker violations and/or other quality metrics.

In embodiments, post-completion tasks may include project deployment and/or release. In embodiments, system logic 40 may be configured to automate deployment and/or release of completed project code that may or may not have been subject to automated code review. In certain circumstances, deploying/releasing a project may include multiple steps, such as, for example, package development, system validations, business approvals, release notes, outage notifications, etc. In conventional systems, such steps may be performed by different groups and manual intervention is often required to proceed from one step to the next. In embodiments, system logic 40 may be configured to automate deployment/release by modeling it as a process to be executed via process manager 50.

In embodiments, post-completion tasks may include validation. For example, and without limitation, after an application is deployed (e.g., via server 12), a defined process may execute a validation step that may validate the application key functionalities by executing test scripts. The test scripts may be built on different testing platforms like QTP, Selenium®, and/or others. In embodiments, process manager 50 may call services of system 10 and/or system logic 40 that may make use of the testing platform APIs to execute scripts. In embodiments, system logic 40 may generate a report (e.g., in step 166), that may include the validation results, such as in an XML format. In embodiment, the report may be viewed, for example, via display 18 and/or user interface. The validation results may be passed back to the process manager 50 (e.g., to determine a next step).

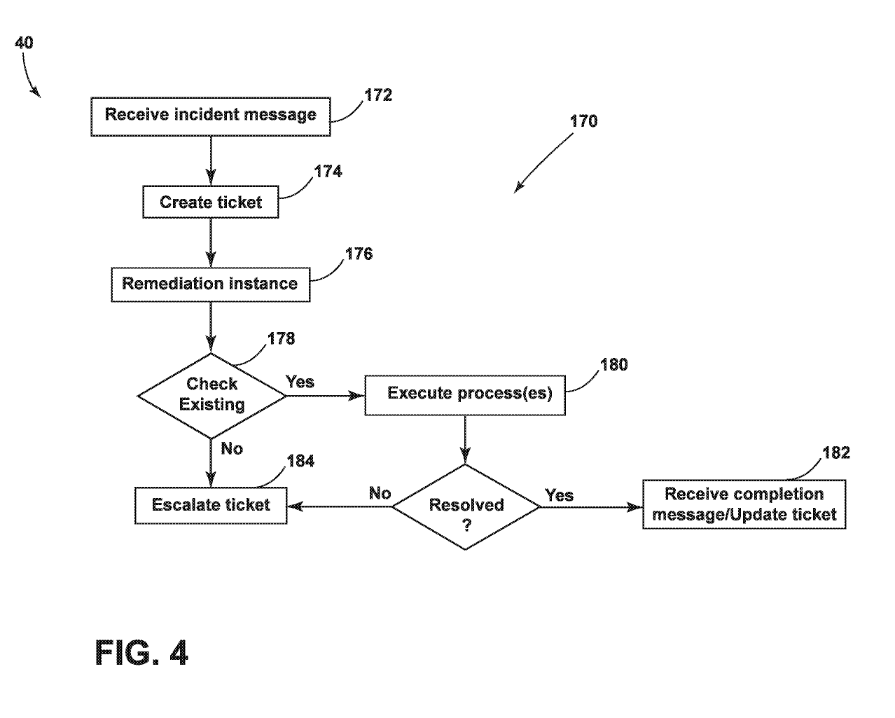

In embodiments, such as generally illustrated in FIG. 4, system logic 40 may be configured to automate certain aspects of IT operations. For example, and without limitation, system logic 40 may be configured for automatically resolving and/or remediating IT issues. In embodiments, IT support may be organized into a plurality of levels of support and each level may include a certain capabilities and/or resources. Support levels may be assigned to IT issues according to complexity and/or difficulty of the issue. In embodiments, the first level of support, or even the first few levels of support may be set up to operate according a predetermined progression 170 of tasks/inquiries. A predetermined progression 170 may include, for example, checking ticket details, checking server details, checking network connection statuses, executing commands on servers, restarting services, etc. In embodiments, system logic 40 may be configured to model, and/or receive as a model, one or more of such progressions as IT support processes to be managed/automated via process manager. Modeling progressions as IT support processes may include selecting relevant tasks from a task library (e.g., prefabricated task library).

In embodiments, IT support processes may be configured for being automatically triggered and/or invoked via process manager. For example, and without limitation, process manager may be configured to communicate with an IT incident reporting tool and/or may be configured to receive an alert if an IT incident is discovered (e.g., via an incident message), such as by an IT monitoring system. In embodiments, IT support processes may be configured as web services (e.g., REST/SOAP), and may be invoked via an IT service management (ITSM) tool and/or an IT monitoring system. For example, and without limitation, an IT monitoring system may be configured to create automatic alerts if certain parameters of hardware (e.g., servers, network devices, etc.) and/or applications are outside of expected ranges.

Referring again to FIG. 4, system logic 40, in step 172, may be configured to receive alerts and/or an incident notification via ITSM tools and/or IT monitoring systems. Then, in steps 174 and 176, system logic 40, via process manager 50, may create a support/incident ticket and/or trigger a new service remediation instance. In step 178, process manager may search for existing IT support processes that may be used to resolve the incident. If an existing IT support process (or multiple support processes) is found, process manager 50 may, in step 180, be configured to execute the relevant IT support process(es) to attempt to automatically remediate the underlying issue. If the IT support process(es) resolves the issue, process manager 50 may, in step 182, receive a resolved notification (e.g., from the ITSM tool and/or the IT monitoring system), and may update the support ticket accordingly. If an existing IT support process is not found or if the executed process(es) does not resolve the issue, process manager 50, in step 184, may update the ticket to reflect that the executed process(es) did not resolve the issue and escalate the ticket to the next level of support.

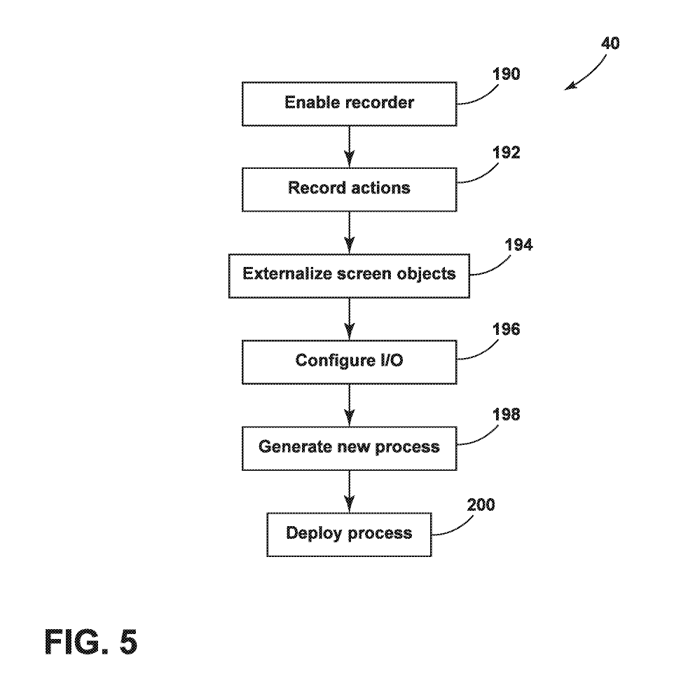

In embodiments, system logic 40 may be configured to automate certain tasks that are typically performed, at least in part, manually by creating a new process that may be managed by process manager 50. In embodiments, such as generally illustrated in FIG. 5, automating manual tasks (including partially manual tasks) may include, in step 190, enabling a task recorder 210. In step 192, the task recorder 210 may record the actions performed for the task. In step 194, system logic 40 may be configured to externalize screen objects. In embodiments, manual actions/interaction with applications may be recorded with details on the application screen, form fields, data entered, navigation details, and/or other information. Each action/interaction may be logically grouped and saved as a recorded process object. A recorded process object may be accessible through a framework API of system 10. Framework API may be configured to provide access to calling process objects, such as via one or more protocols (e.g., REST, SOAP, Java message service (JMS), etc.). The recorded process object may be BPMN 2.0 compliant. In step 196, system logic 40 may configure inputs and/or outputs that are received and/or entered during the manual task. In embodiments, system logic 40 may, in step 198, generate the new process according to the recorded actions, the externalized screen objects, and/or the inputs and outputs. Once the new process is generated, process manager 50, in step 200, may be configured to deploy/execute the process, which may complete the automation of the manual task and/or eliminate the need for manual intervention in completing the desired task.

In embodiments, system logic 40 may be configured to permit system 10 to be scalable, such as via independence of various components and/or loose coupling between various components. For example, and without limitation, additional service adapters 70_{N} may be added for new and/or difference services. In embodiments, system logic 40 may be configured to permit system 10 to be portable. For example, and without limitation, process manager 50 may be designed with a n-tier architecture on a Java® platform. An n-tier architecture may include various aspects of embodiments of system logic 40 being physically and/or logically separated from each other. For example, and without limitation, process manager 50, user interface 80, and/or database 130 may be physically and/or logically separated from each other such that modifications to one may not require modifications to the others.

In embodiments, system 10 may include a hybrid cloud-compatible configuration. For example, and without limitation, system 10 may be configured to manage both private and public could environments, which may be defined as virtual data centers in system 10. System logic 40 may be configured to provision virtual machines 142 corresponding to such environments and/or to manage such environments. In embodiments, all virtual machines 142 for multiples environments may be viewed in a single pane (e.g., on display 18).

In embodiments, system 10 may be deployed, for example, via a cloud configuration and/or a virtual appliance configuration. In embodiments, if system 10 is deployed via a public cloud configuration, firewall rules may be modified and/or virtual private network (VPN) tunneling may be used to connect system 10 with certain external systems (e.g., client systems).

It should be understood that a system and/or a processor (e.g., system 10 and/or processor 14), as described herein may include a conventional processing apparatus known in the art, capable of executing preprogrammed instructions stored in an associated memory, all performing in accordance with the functionality described herein. In embodiments, processor 14 may be specifically configured for performing one or more of the functions described herein. To the extent that the methods described herein are embodied in software, the resulting software can be stored in an associated memory, such as memory 16, and can also constitute the means for performing such methods. Such a system or processor (e.g., system 10 and/or processor 14), may further be of the type having both ROM, RAM, a combination of non-volatile and volatile (modifiable) memory so that any software may be stored and yet allow storage and processing of dynamically produced data and/or signals.

It should be further understood that an article of manufacture in accordance with this disclosure includes a non-transitory computer-readable storage medium (e.g., memory 16), having a computer program encoded thereon for implementing the system logic 40 and other functionality described herein. The computer program may include code to perform one or more of the methods disclosed herein. Such embodiments may be configured to execute on one or more processors (e.g., processor 14), multiple processors that are integrated into a single system or are distributed over and connected together through a communications network (e.g., network 30), and/or where the network may be wired or wireless. Code for implementing logic 40 may, when executed by a processor (e.g., processor 14), cause a plurality of transistors to change from a first state to a second state. A specific pattern of change (e.g., which transistors change state and which transistors do not), may be dictated, at least partially, by logic 40 and/or the code. For example, and without limitation, in embodiments, processor 14 of system 10 may include a plurality of transistors that change state according to system logic 40 and/or code that implements system logic 40.

In embodiments, the term “module” includes an identifiable portion of computer code, computational instructions, executable instructions, data, and/or a computational object to achieve a particular function, operation, processing, and/or procedure. A module may be implemented via software, hardware/circuitry, or a combination of software and hardware. A module, for example, may comprise one or more physical or logical blocks of computer instructions that may, for instance, be organized as an object, procedure, or function. In embodiments, executables of a module may not be physically located together and/or may include disparate instructions stored in different locations which, when joined logically together, may comprise the module and/or achieve the stated purpose for the module. In embodiments, a module may include a single instruction, many instructions, and/or may be distributed over several different code segments, among different programs, and/or across several memory devices. In embodiments, modules may represent data and may be embodied in any suitable form and/or may be organized within any suitable type of data structure. The represented data may be collected as a single data set and/or may be distributed over different locations, such as different storage/memory devices.

The foregoing numerous embodiment solve one or more problems known in the art.

It should be understood that a processor 14, particularly a main electronic control unit (i.e., processor 14), as described herein may include conventional processing apparatus known in the art, capable of executing pre-programmed instructions stored in an associated memory, all performing in accordance with the functionality described herein. To the extent that the methods described herein are embodied in software, the resulting software can be stored in an associated memory and can also constitute the means for performing such methods. Implementation of certain embodiments, where done so in software, would require no more than routine application of programming skills by one of ordinary skill in the art, in view of the foregoing enabling description. Such an electronic control unit may further be of the type having both ROM, RAM, a combination of non-volatile and volatile (modifiable) memory so that any software may be stored and yet allow storage and processing of dynamically produced data and/or signals.

It should be further understood that an article of manufacture in accordance with this disclosure includes a computer-readable storage medium having a computer program encoded thereon for implementing the logic 40 and other functionality described herein. The computer program includes code to perform one or more of the methods disclosed herein. Such embodiments may be configured to execute one or more processors, multiple processors that are integrated into a single system or are distributed over and connected together through a communications network, and where the network may be wired or wireless.

Although only certain embodiments have been described above with a certain degree of particularity, those skilled in the art could make numerous alterations to the disclosed embodiments without departing from the scope of this disclosure. Joinder references (e.g., attached, coupled, connected, and the like), are to be construed broadly and may include intermediate members between a connection of elements and relative movement between elements. As such, joinder references do not necessarily imply that two elements are directly connected/coupled and in fixed relation to each other. Additionally, the terms “communicate” and “communication” are meant to be construed broadly to encompass both wired and wireless connections and communications. The use of “e.g.” throughout the specification is to be construed broadly and is used to provide non-limiting examples of embodiments of the disclosure, and the disclosure is not limited to such examples. It is intended that all matter contained in the above description or shown in the accompanying drawings shall be interpreted as illustrative only and not limiting. Changes in detail or structure may be made without departing from the present disclosure as defined in the appended claims.

What is claimed is:

1. A data communication system, comprising:
a computer server comprising:
a processor,
a memory; and
a computer program encoded on said memory, said computer program configured to implement system logic when executed by said processor, said system logic including:
a process manager,
a user interface;
a communication bus; and
a database;
wherein the process manager is configured to automatically execute a plurality of custom processes.

2. The system of claim 1, wherein at least one of the plurality of custom processes corresponds to a code development project, and the process manager is further configured for:
receiving a request for the code development project;
receiving, via the user interface, a request for an electronic environment, the electronic environment configured for modifying the code development project;
provisioning the electronic environment according to the request; and,
providing the environment via a virtual machine.

3. The system of claim 2, wherein the provisioning includes:
determining an environment type from the request;
determining an environment blueprint of the requested electronic environment; and
invoking a target communication interface, according to the determined environment type and determined environment blueprint, to create the virtual machine.

4. The system of claim 1, wherein the process manager is further configured to:
receive a project completion message upon complete of the project;
analyze the project according to a plurality of project review rules; and
generate a report according to the review of the completed project.

5. The system of claim 1, wherein at least one of the plurality of custom processes
corresponds to an information technology (IT) incident and the processor is configured to automatically remediate the IT incident.

6. The system of claim 5, wherein automatically remediating the IT incident includes:
receiving an incident message including information corresponding to the IT incident;
creating an incident ticket according to the incident message;
determining, according to the incident ticket, if one or more existing processes are configured for remediating the IT incident;
executing one or more existing processes if the one or more existing processes are configured for remediating the IT incident; and
escalating the incident ticket if the one or more existing processes are not configured for remediating the IT incident.

7. A method for high efficiency data communications via a computer network, the method comprising:
providing a computer server including a processor and a memory coupled to the processor,
providing a system logic disposed in said memory, said system logic comprising at least one of instructions and code;
receiving, via the computer server, a process execution request; and
automatically executing, via a process manager of said system logic, a custom process according to the process execution request.

8. The method of claim 7, comprising exporting the process execution request to a process tracking tool.

9. The method of claim 8, wherein the custom process corresponds to a code development project, and automatically executing the custom process comprises:
receiving an request for an electronic environment, the electronic environment configured for modifying the code development project;
provisioning the electronic environment according to the request; and,
providing the environment via a virtual machine.

10. The method of claim 9, wherein the provisioning includes:
determining an environment type according to the request;
determining an environment blueprint according to the request; and
invoking a target communication interface according to the determined environment type and determined environment blueprint, to create the virtual machine.

11. The method of claim 10, further comprising:
receiving a project completion message upon completion of the project;
analyzing the completed project according to a plurality of project review rules; and
generating a report according to the review of the completed project.

12. The method of claim 11, wherein analyzing the completed project includes automatically applying a plurality test cases to the project.

13. The method of claim 12, wherein analyzing the completed project includes determining a project coverage value.

14. The method of claim 13, wherein the project coverage value corresponds to an amount of the completed project that has been tested via the plurality of test cases.
